(19) United States
(12) Patent Application Publication
(10) Pub. No.: US 2013/0308995 A1
(43) Pub. Date: Nov. 21, 2013

(54) BALL JOINT DEVICE

(71) Applicant: EUROCOPTER, Marignane (FR)

(72) Inventor: Vincent Girard, Venelles (FR)

(73) Assignee: EUROCOPTER, Marignane (FR)

(21) Appl. No.: 13/889,445

(22) Filed: May 8, 2013

(30) Foreign Application Priority Data
May 16, 2012 (FR) 12 01408

(51) Int. Cl. F16C 11/06

(52) U.S. Cl. CPC F16C 11/06
USPC 403/27

(57) ABSTRACT

A ball joint device (1) having an outer cage (2) and a spherical ball (3), anti-friction means (5) being interposed between the outer cage (2) and the spherical ball (3). The ball joint device (1) comprises wear detection means (10) co-operating with the anti-friction means (5) between the outer cage (2) and the spherical ball (3), the wear detection means (10) having a first color that is distinct from a second color of said anti-friction means (5) in order to indicate wear visually by means of a change in color.

### CROSS REFERENCE TO RELATED APPLICATIONS

This application claims priority to French patent application No. FR 12/01408 filed on May 16, 2012, the content of which is incorporated in its entirety by reference herein.

### BACKGROUND OF THE INVENTION

(1) Field of the Invention

The present invention relates to a ball joint device. In order to make a ball joint between two mechanical parts, an operator may make use of a ball joint device. Such a device is sometimes referred to as a “knuckle” or as a “universal joint”, for example.

(2) Description of Related Art

A ball joint device may comprise an outer cage and a ball. The ball is then inserted in the outer cage.

It should be observed that the ball itself is sometimes referred to as a “spherical” ball. However such a term may seem inappropriate insofar as the ball sometimes has two flats at two opposite ends. Thus, the ball is actually a sphere that has been truncated at both poles.

Nevertheless, since this term is in widespread use, the ball of a ball joint device is referred to below as a “spherical” ball regardless of whether the sphere has or has not been truncated.

Under such conditions, the outer cage may be fastened by conventional means to a first mechanical part. Likewise, the spherical ball may be fastened to a second mechanical part, e.g. by using a fastener pin passing through the spherical ball via its truncated poles.

The fastener pin may be secured to the spherical ball or it may pass part of the way through the spherical ball.

A spherical ball must thus comprise an optionally truncated sphere that is possibly secured to at least one pin.

Such ball joint devices are in widespread use.

Nevertheless, the spherical ball rubs against an inner wall of the outer cage. The spherical ball and the outer cage are then naturally subjected to wear during the lifetime of the ball joint device.

The wear of the spherical ball and of the outer cage leads to unwanted play being created between the spherical ball and the outer cage. Consequently, this play ends up by requiring the ball joint device to be replaced in compliance with a replacement criterion established by the manufacturer.

This replacement criterion may consist in specifying maximum acceptable amount of play between the outer cage and the spherical ball. This replacement criterion would appear to be consistent with the problem encountered. Nevertheless, it is difficult to measure the amount of play that exists between the outer cage and the spherical ball.

An operator then tends to evaluate it by touch by moving the spherical ball relative to the outer cage. Under such circumstances, such evaluation includes a certain amount of inaccuracy.

In addition, the operator often moves the ball joint device while the ball joint device is itself fastened to the parts it assembles together.

However, the ball joint device is often prestressed in such a configuration. The operator can then find it difficult to overcome the prestress in order to evaluate any play that might be present between the outer cage and the spherical ball.

In order to limit wear by friction, anti-friction means may be interposed between the spherical ball and the outer cage. The anti-friction means may be fastened to the inner wall of the outer cage facing the spherical ball, or conversely to the outer wall of the spherical ball where it faces the outer cage.

Such anti-friction means are sometimes referred to as a “liner”.

Although effective, the anti-friction means, the spherical ball, and/or the outer cage nevertheless suffer wear while they are in use.

The technological background includes the following documents: FR 2 196 051 and GB 1 392 885.

Those documents describe a ball joint device having a spherical ball referred to as a “ball stud” that is inserted in an outer cage.

The spherical ball has a fastener pin projecting from the outer cage, and a flat opposite said fastener pin. The outer cage is also provided with an annular load-carrying bearing and a wear take-up cup surrounding the spherical ball. The cup is pressed against the bearing by a ring.

The cup also has a cylindrical protrusion. The cylindrical protrusion includes a duct facing the flat of the spherical ball, which duct is fitted with a greasing system. In addition, a cap may be engaged as a force-fit on the protrusion.

The protrusion tends to project from the outer cage. Nevertheless, when the members of the ball joint device become worn, the protrusion tends to enter into the outer cage.

The protrusion thus represents visual means for detecting wear. The protrusion may be colored in order to make it easier to see, but color is nevertheless not required for detecting wear.

Documents FR 2 773 131 and U.S. Pat. No. 6,533,491 present a ball joint device for a motor vehicle. The device includes a bearing defining a supporting surface. The bearing moves as the spherical ball wears in order to activate wear indicating means.

Documents FR 2 196 051 & GB 1 392 885, and FR 2 773 131 & U.S. Pat. No. 6,533,491 thus provide mechanical means that move as a result of a spherical ball suffering wear. In one device a protrusion moves in order to signal the wear, whereas in the other device a bearing moves in order to activate wear indicating means.

Document EP 0 632 207 describes a ball joint device having a spherical ball and an outer cage.

That device includes anti-friction means inserted between the spherical ball and the outer cage. The anti-friction means comprise a liner of polymer material made up of two half-shells.

The wear of the device is measured by performing an electrical conductivity measurement.

Document WO 2005/116465 describes a device for detecting and/or indicating wear of an anti-friction layer arranged between a first surface and a second surface of a bearing.

That device has a finger with one end facing a first surface, and a second end arranged to follow the movement of a second surface. The movement of a finger over a certain distance provides information about wear to an indicator.

Document US 2005/207830 suggests using an electrode.

Also known are the following documents: U.S. Pat. No. 6,152,637, and EP 0 039 968.

### BRIEF SUMMARY OF THE INVENTION

An object of the present invention is thus to provide a ball joint device that seeks to make it easier to detect play that requires the ball joint device to be replaced.

According to the invention, a ball joint device is provided with an outer cage and a spherical ball, anti-friction means being interposed between the outer cage and the spherical ball.

In addition, the ball joint device includes wear detection means co-operating with the anti-friction means between the outer cage and the spherical ball, the wear detection means having a first color that is distinct from a second color of the anti-friction means in order to indicate wear visually by means of a change in color.

The wear detection means and the anti-friction means are stacked and of different colors in order to indicate wear.

Depending on the embodiment, the wear detection means may either be fusible means suitable for being destroyed by friction, or on the contrary means that appear as a result of the anti-friction means wearing.

Independently of the variant, the wear detection means make it possible visually to observe wear that ought to lead to the device being replaced, this wear giving rise to a change of color within the device.

The replacement criterion then becomes a replacement criterion associated with the appearance or the disappearance of the color of the wear detection means, unlike the prior art in which a criterion is provided that is associated with a mechanical part moving in translation, for example.

The device of the present invention thus provides wear detection means that are simple and different from known electrical or mechanical devices.

The device may also include one or more of the following additional characteristics.

In a first embodiment, the wear detection means may be fastened on an outer wall of the spherical ball facing the outer cage, the anti-friction means being fastened to the wear detection means and covering the wear detection means, the anti-friction means being in contact with the outer cage and movable relative to the outer cage.

When the device is used, the anti-friction means thus rub against the inner wall of the outer cage. This results in at least local erosion of the anti-friction means.

When the erosion reaches a maximum, the anti-friction means no longer cover the wear detection means, at least locally.

Since the anti-friction means present a color that is different from the wear detection means, an operator can easily see that the wear detection means have been laid bare, at least locally. The operator can then deduce that it is time to replace the ball joint device.

By way of example, the anti-friction means may present a friction thickness that is less than or equal to a maximum amount of play due to wear as defined by the manufacturer in order to guarantee that the device is operational, so that it no longer covers the wear detection means, at least locally, when the maximum amount of play due to wear is reached.

The maximum amount of play due to wear is defined by the manufacturer in order to guarantee that the device is operational.

In addition, this thickness is said to be the “friction thickness” in order to distinguish it from the other thicknesses mentioned in the present document.

In a second embodiment, the anti-friction means are secured to an inner wall of the outer cage facing the spherical ball, the wear detection means being fastened on the spherical ball and being in contact with the anti-friction means and movable relative to the anti-friction means.

When the device is in use, the wear detection means then rub against the anti-friction means. This results in at least local erosion of the wear detection means, and possibly of the anti-friction means.

When the erosion reaches a maximum, the wear detection means disappear. Its first color therefore no longer appears, at least locally, with the spherical ball being laid bare locally.

An operator can then easily see the resulting change in color and can deduce therefrom that it is time to replace the ball joint device.

By way of example, the wear detection means present a wear thickness less than or equal to a maximum amount of play due to wear so as to no longer cover the spherical ball, at least locally, when the maximum amount of play due to wear is reached. This thickness is referred to as “wear thickness” in order to distinguish it from the other thicknesses mentioned in the present document.

In a third embodiment, the anti-friction means are secured to an inner wall of the outer cage facing the spherical ball. The wear detection means comprise a liquid dye that is arranged in a plurality of receptacles, each receptacle being formed at least in part in the anti-friction means.

While the device is in use, the anti-friction means then rub against the inner wall of the outer cage. This leads to at least local erosion of the anti-friction means.

When the erosion reaches a maximum, the anti-friction means no longer close at least one of the receptacles. The liquid dye then spreads out from the receptacles that have been opened.

An operator can easily see the leak of dye by visual inspection. The operator deduces therefrom that it is time to replace the ball joint device.

For example, the anti-friction means comprises a plurality of grooves open to the inner wall, each receptacle being defined by the outer cage and the anti-friction means. The outer cage may also include notches in register with each of the grooves, each receptacle being defined by a groove and a corresponding notch.

This characteristic seeks to facilitate manufacture of the ball joint device.

In addition, the anti-friction means may present a buffer thickness between each receptacle and the spherical ball, the buffer thickness being less than or equal to a maximum amount of play due to wear. This thickness is said to be “buffer” thickness in order to distinguish it from the other thicknesses mentioned in the present document.

### BRIEF DESCRIPTION OF THE SEVERAL VIEWS OF THE DRAWINGS

The invention and its advantages appear in greater detail from the context of the following description of embodiments given by way of illustration and with reference to the accompanying figures, in which:

FIG. 1 is a section showing a first embodiment;

FIG. 2 is a section showing a second embodiment; and

FIG. 3 is a section showing a third embodiment.

### DETAILED DESCRIPTION OF THE INVENTION

Elements that are present in more than one of the figures are given the same references in each of them.

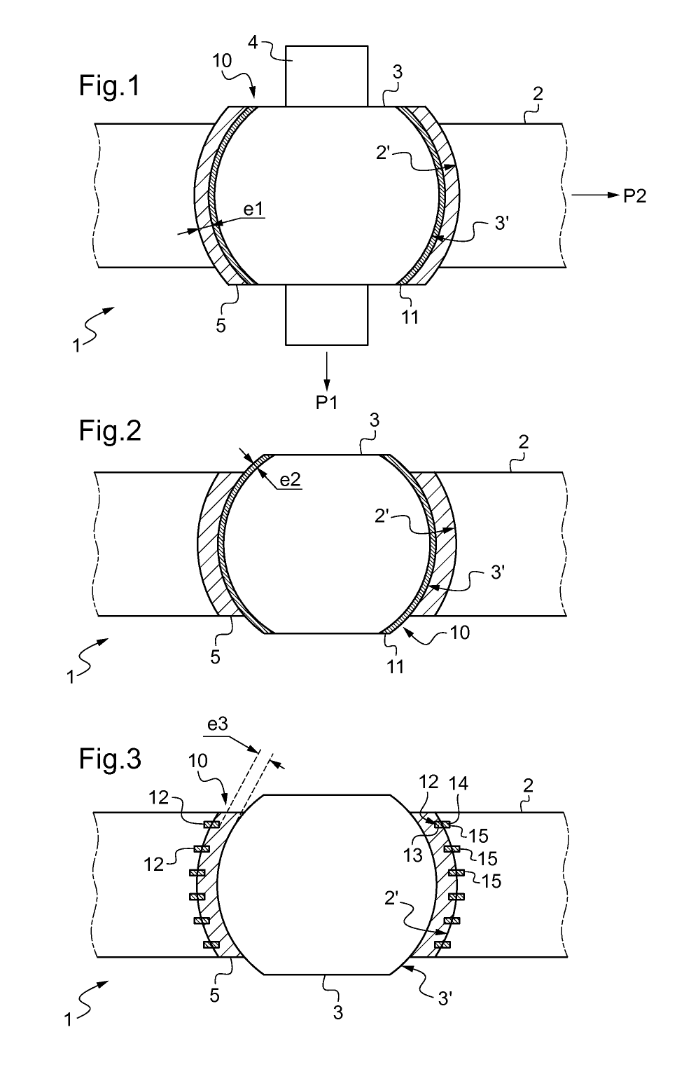

FIG. 1 shows a ball joint device 1 in a first embodiment for hinging a first mechanical part P1 to a second mechanical part P2.

Independently of the embodiment, the ball joint device 1 includes an outer cage 2 having an inner wall 2′. The inner wall 2′ also defines a through orifice passing through the outer cage 2.

Under such circumstances, the ball joint device 1 includes a spherical ball 3 arranged in said orifice. The spherical ball 3 then has an outer wall 3′ of spherical shape facing the inner wall 2′.

The inner wall 2′ of the outer cage 2 matches the shape of the outer wall 3′ of the spherical ball 3.

The spherical ball 3 shown is a spherical ball that is truncated at its poles and that is suitable for having a fastener shaft 4 passed therethrough. Nevertheless, other known types of spherical ball can be envisaged, e.g. the prior art spherical balls as described above.

Two mechanical parts can then be hinged together by the ball joint device. The spherical ball may be secured to a first mechanical part P1 and the outer cage 2 may be secured to a second mechanical part P2.

The ball joint device 1 is also provided with anti-friction means 5 for slowing down wear of the device.

The anti-friction means 5 are then arranged between the outer cage 2 and the spherical ball 3.

The ball joint device 1 is also provided with wear detection means 10 for informing an operator of wear that requires the ball joint device 1 to be replaced.

The wear detection means 10 comprise a layer of detection material stacked on a layer of friction material of the anti-friction means 5. This layer of detection material may be a continuous layer as in the first and second embodiment, or it may be a discontinuous layer as in the third embodiment.

Under such circumstances, the wear detection means 10 co-operate with the anti-friction means 5 between the outer cage 2 and the spherical ball 3 in order to visually indicate wear via a change in color. For this purpose, the wear detection means 10 possess a first color that is distinct from a second color of the anti-friction means 5.

In the first embodiment of FIG. 1, the wear detection means 10 are secured to the outer wall 3′ of the spherical ball 3. For example, the wear detection means comprise a layer made from a mass-colored liner with this layer being adhesively bonded to the outer wall in the same manner as the anti-friction means.

It is possible to envisage covering the outer wall solely in a layer of paint, which then presents mechanical surface behavior that is better than that of the anti-friction means.

The anti-friction means 5 then comprise a layer of friction material of conventional type fastened to the wear detection means 10. For example, the anti-friction means may be adhesively bonded to the wear detection means 10.

Under such circumstances, the anti-friction means cover the wear detection means 10 and they are also in contact with the outer cage 2.

Since the anti-friction means 5 are movable relative to the outer cage 2 together with the spherical ball, the anti-friction means 5 tend to become worn over time.

This wear then gives rise to erosion of the anti-friction means making it possible, at least locally, to see the wear detection means. The first color of the wear detection means 10 then becomes visible.

The anti-friction means 5 may optionally present a friction thickness e1 that is less than or equal to a maximum amount of play due to wear as defined by the manufacturer. When this friction thickness has been eroded, the wear detection means appear, which implies that the ball joint device 1 needs to be replaced.

FIG. 2 shows a second embodiment.

In this second embodiment, the anti-friction means 5 are secured to the inner wall 2′ of the outer cage 2, e.g. by adhesive.

In contrast, the wear detection means 10 are secured to the outer wall 3′ of the spherical ball 3. In addition, the wear detection means 10 are in contact with the anti-friction means 5.

The wear detection means 10 are then movable relative to the anti-friction means 5, together with the spherical ball 3.

Consequently, this relative movement leads to friction between the anti-friction means 5 and the wear detection means.

As soon as the first color characteristic of the wear detection means 10 disappears under the effect of such friction, an operator can deduce that the ball joint device 1 needs to be changed. It may be necessary for replacement to take place at once, or within a period as predetermined by the manufacturer, for example.

For this purpose, the wear detection means 10 optionally present a wear thickness e2 that is less than or equal to a maximum amount of play due to wear that it no longer covers the spherical ball, at least locally, when the maximum amount of play due to wear is reached.

In the third embodiment of FIG. 3, the anti-friction means 5 are secured to the inner wall 2′ of the outer cage 2. The anti-friction means are also in contact with the outer wall 3′ of the spherical ball 3.

The wear detection means 10 then include a liquid dye 12 that fills a plurality of receptacles 15. Each receptacle 15 is formed at least in part in the anti-friction means 5.

Thus, the anti-friction means 5 described include a plurality of grooves 13. Each groove 13 is open to the inner wall 2′.

A receptacle may then be defined by a single groove only.

Nevertheless, in the variant shown, the outer cage 2 also includes notches 14 in register with each of the grooves 13. Under such circumstances, each receptacle 15 is defined by a groove 13 and a corresponding notch 14.

Independently of the variant, each receptacle 15 is defined by the outer cage 2 and by the anti-friction means 5.

Finally, the anti-friction means 5 shown in FIG. 3 are provided with buffer thickness e3 between each receptacle 15 and the spherical ball 3. This buffer thickness e3 is then possibly less than or equal to a maximum amount of play due to wear.

Naturally, the present invention may be subjected to numerous variations as to its implementation. Although several embodiments are described above, it will readily be understood that it is not conceivable to identify exhaustively all possible embodiments. It is naturally possible to envisage replacing any of the means described by equivalent means without going beyond the ambit of the present invention.

What is claimed is:

1. A ball joint device having an outer cage and a spherical ball, anti-friction means being interposed between the outer cage and the spherical ball, wherein the ball joint device includes wear detection means co-operating with the anti-friction means between the outer cage and the spherical ball, the wear detection means having a first color that is distinct from a second color of said anti-friction means in order to indicate wear visually by means of a change in color.

2. A device according to claim 1, wherein the wear detection means are fastened on an outer wall of said spherical ball facing the outer cage, said anti-friction means being fastened to the wear detection means and covering the wear detection means, the anti-friction means being in contact with the outer cage and movable relative to said outer cage.

3. A device according to claim 2, wherein said anti-friction means present a friction thickness (e1) that is less than or equal to a maximum amount of play due to wear in order to no longer cover said wear detection means, at least locally, when the maximum amount of play due to wear is reached.

4. A device according to claim 1, wherein said anti-friction means are secured to an inner wall of the outer cage facing the spherical ball, the wear detection means being fastened on said spherical ball and being in contact with said anti-friction means and movable relative to the anti-friction means.

5. A device according to claim 4, wherein said wear detection means present a wear thickness (e2) less than or equal to a maximum amount of play due to wear so as to no longer cover said spherical ball, at least locally, when the maximum amount of play due to wear is reached.

6. A device according to claim 1, wherein said anti-friction means are secured to an inner wall of the outer cage facing the spherical ball, said wear detection means comprising a liquid dye that is arranged in a plurality of receptacles, each receptacle being formed at least in part in said anti-friction means.

7. A device according to claim 6, wherein said anti-friction means comprises a plurality of grooves open to said inner wall, each receptacle being defined by said outer cage and said anti-friction means.

8. A device according to claim 7, wherein the outer cage includes notches in register with each of the grooves, each receptacle being defined by a groove and a corresponding notch.

9. A device according to claim 6, wherein said anti-friction means presents a buffer thickness (e3) between each receptacle and said spherical ball, said buffer thickness (e3) being less than or equal to a maximum amount of play due to wear.
